(19) United States
(12) Patent Application Publication
(10) Pub. No.: US 2013/0133318 A1
(43) Pub. Date: May 30, 2013

(54) HYDRAULIC TRAVEL DRIVE WITH A CLOSED HYDRAULIC CIRCUIT AND METHOD FOR OPERATING SUCH A TRAVEL DRIVE

(71) Applicant: Robert Boscher GmbH, Stuttgart (DE)

(72) Inventors: Karl-Heinz Vogl, Ummendorf (DE); Michael Schuette, Langenau (DE)

(73) Assignee: Robert Bosch Gmbh, Stuttgart (DE)

(21) Appl. No.: 13/682,803

(22) Filed: Nov. 21, 2012

(30) Foreign Application Priority Data
Nov. 24, 2011 (DE) 10 2011 119 309.3

(51) Int. Cl. F15B 1/02

(52) U.S. Cl. CPC F15B 1/02
USPC 60/327; 60/325; 60/459

(57) ABSTRACT

A hydraulic travel drive includes a primary hydraulic machine and at least one secondary hydraulic machine connected in a closed hydraulic circuit via a first and a second working line. A first accumulator is connected via a first valve to the first working line and via a second valve to the second working line. A second accumulator is connected via a third valve to the first working line and via a fourth valve to the second working line. The four valves are non-proportional switching valves each having two defined switching positions. A method for operating the drive includes comparing the high pressure working line to the first accumulator. If pressure in the accumulator is lower than in the working line, the first accumulator is connected to the high pressure working line for charging until pressure in the accumulator corresponds to that of the working line.

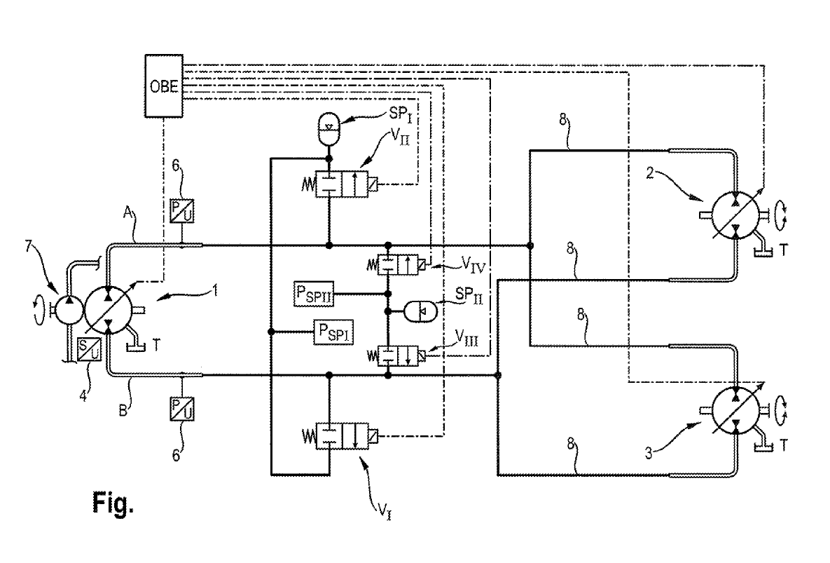

This application claims priority under 35 U.S.C. §119 to patent application no. DE 10 2011 119 309.3, filed on Nov. 24, 2011 in Germany, the disclosure of which is incorporated herein by reference in its entirety.

### BACKGROUND

The disclosure relates to a hydraulic travel drive with a closed hydraulic circuit and to a method for the regenerative operation of a such a travel drive.

In hydraulic travel drives with a closed hydraulic circuit, in travel a primary hydraulic machine acting as a pump is driven by an internal combustion engine. At least one secondary hydraulic machine which acts as a motor and to which, for example, a wheel is coupled is driven by two working lines.

The publication DE 10 2008 021 889 A1 shows such a travel drive with a closed hydraulic circuit, in which two hydraulic accumulators are connected to the two working lines via a valve block. These hydraulic accumulators serve for recovering energy during braking by charging one of the hydraulic accumulators from the working line carrying high pressure. For example during acceleration, the energy from the previously charged hydraulic accumulator can be delivered again to the same or the other working line, depending on the direction of travel.

The publication DE 10 2006 060 014 B4 shows a similar travel drive with a closed hydraulic circuit, in which two accumulators are likewise connected to the two working lines. In this case, for each accumulator, two seat valves are disclosed, via which the respective accumulator can be connected alternately to both working lines. The seat valves are designed as complicated logic valves.

The disadvantage of the last-mentioned travel drive is that the valve bodies of the logic valves, when in regulating positions, generate losses in the form of waste heat.

By contrast, the object on which the disclosure is based is to provide a travel drive with a closed hydraulic circuit and a method for operating it, the travel drive being simplified in terms of apparatus and its energy efficiency being improved.

This object is achieved by means of a travel drive and a method for operating the travel drive having the features of the disclosure.

### SUMMARY

The hydraulic travel drive according to the disclosure has a primary hydraulic machine and at least one secondary hydraulic machine which are connected to one another in a closed hydraulic circuit via a first and a second working line. In this case, a first accumulator can be connected via a first valve to the first working line and via a second valve to the second working line. Furthermore, a second accumulator can be connected via a third valve to the first working line and via a fourth valve to the second working line. The four valves are non-proportional switching valves, each with an open and a closed switching position. A travel drive is consequently provided which is simplified in terms of apparatus and the energy efficiency of which in the recovery of braking energy is improved.

In a preferred application, a plurality of wheels are driven by the travel drive. A plurality of secondary hydraulic machines are then provided correspondingly, each secondary hydraulic machine being connected to the first and to the second working line via a respective branch line.

Further advantageous refinements of the disclosure are described in the dependent patent claims.

In an especially cost-effective solution, the switching valves are pilot-controlled nonreturn valves.

A preferred development has an electronic control unit, via which a respective pivot angle and a respective rotational speed of the hydraulic machines can be detected. Furthermore, the four switching valves are switched by the control unit. In this case, the control unit may be arranged on the primary hydraulic machine or be formed integrally with the latter. The control unit constitutes the central intelligence of the travel drive and regulates the recovery of braking energy.

For this purpose, an arrangement of pressure sensors is preferred, via which the respective inlet and outlet pressures of the hydraulic machines and of the two accumulators can be detected and can be transferred to the control unit.

The pressure sensors may be arranged at the connections of the hydraulic machines or on the connected lines, that is to say, as regards the primary hydraulic machine, on the two working lines and, as regards the secondary hydraulic machines, on the branch lines.

In a preferred application of the travel drive according to the disclosure, it is preferable if the primary hydraulic machine is coupled to an internal combustion engine, in particular to a diesel engine, and can be driven by the latter. The primary hydraulic machine can then be operated also as a motor and at the same time discharge excess braking energy to the internal combustion engine.

The method according to the disclosure for operating an above-described travel drive serves for the recuperation of braking energy and has the steps: recognition of a braking mode of the travel drive; comparison of the pressure in the working line carrying high pressure with the pressure of the first accumulator; if pressure in the accumulator is lower than in the working line, on the one hand, the first accumulator is connected to the working line carrying high pressure and is thereby charged and, on the other hand, the second accumulator is connected to the working line carrying low pressure for the purpose of volume compensation; the pressure of the working line carrying high pressure is compared permanently with the pressure of the first accumulator; until pressure in the charged accumulator corresponds approximately to that of the working line; and after charging, the two accumulators are separated from the two working lines.

In a continuation of the method according to the disclosure, there follow the steps: recognition of a travel mode, in particular acceleration mode, of the travel drive; comparison of the pressure in the working line carrying high pressure with the pressure of the first accumulator; and if the pressure in the accumulator is higher than in the working line, on the one hand, the first accumulator is connected to the working line carrying high pressure for the purpose of infeed and, on the other hand, the second accumulator is connected to the working line carrying low pressure for the purpose of volume compensation.

In this case, the connection and separation of the accumulators to and from the working lines take place via the switching valves.

In the braking mode, preferably after the connection of the first accumulator to the working line carrying high pressure and the connection of the second accumulator to the working line carrying low pressure, regulation of the braking torque on an output shaft of the at least one secondary hydraulic machine takes place as a result of the setting of a pivot angle of the secondary hydraulic machine. The latter is in this case operated as a pump.

In the braking mode, after the separation of the two accumulators from the two working lines, particularly on account of a maximum charge or filling, regulation of the braking torque may take place via high-pressure valves of the primary hydraulic machine.

In the travel mode, in particular acceleration mode, preferably after the connection of the first accumulator to the working line carrying high pressure and the connection of the second accumulator to the working line carrying low pressure, travel regulation, in particular acceleration regulation, takes place as a result of the setting of the pivot angle of the at least one secondary hydraulic machine. The latter is in this case operated as a motor.

Travel regulation may additionally take place as a result of the setting of the pivot angle of the primary hydraulic machine operated as a pump.

In an especially preferred development of the method according to the disclosure, the recognition of the braking mode and the recognition of the travel mode, in particular of the acceleration mode, take place via the respective rotational speeds and the respective inlet and outlet pressures of the hydraulic machines.

If storage of the pressure value of the charged accumulator in the control unit takes place before the separation of the two accumulators from the two working lines, it is possible, in the next travel mode, for the charged accumulator to be cut in for the purpose of the correct pressure level of the working line carrying high pressure.

### BRIEF DESCRIPTION OF THE DRAWING

An exemplary embodiment of the disclosure is described in detail below by means of a figure.

The FIGURE shows a hydraulic circuit diagram of the exemplary embodiment of the travel drive according to the disclosure.

### DETAILED DESCRIPTION

In a closed hydraulic circuit, a primary adjustable hydraulic machine 1 is provided which can be driven by an internal combustion engine (not shown). The primary hydraulic machine 1 can be operated as a pump and as a motor, its pivot angle being adjustable via a zero stroke volume. The setting of the pivot angle takes place via an electronic control unit OBE which is fastened to a housing of the hydraulic machine 1. The pivot angle is monitored via a displacement transducer 4 and is transferred to the control unit OBE.

A first working line B and a second working line A are connected to the primary hydraulic machine 1. Two secondary hydraulic machines 2, 3 are connected to each working line A, B via two branch lines 8. These hydraulic machines serve as wheel motors and can be used as pumps for the recovery of braking energy, their pivot angles likewise being adjustable via zero. The setting of the pivot angles takes place electroproportionally via the control unit OBE.

The travel drive is designed as a closed hydraulic circuit which can be supplied, via a feed pump 7 coupled to the internal combustion engine, with replacement pressure medium for a pressure medium which may have escaped.

A first pressure accumulator SP_{I} is connected via a first pilot-controlled nonreturn valve V_{I} to the first working line B and via a second pilot-controlled nonreturn valve V_{II} to the second working line A. In a comparable way, a second pressure accumulator SP_{II} is connected via a third pilot-controlled nonreturn valve V_{III} to the first working line B and via a fourth pilot-controlled nonreturn valve V_{IV} to the second working line A. The four pilot-controlled nonreturn valves V_{I}, V_{II}, V_{III}, V_{IV} have a closed switching position prestressed by a spring and an opening position switchable from the control unit OBE by means of an electrical actuator.

A pressure sensor P_{SPI} and P_{SPII} is connected in the respective line portion between the accumulator SP_{I} and SP_{II} and the two assigned nonreturn valves V_{I}, V_{II} and V_{III}, V_{IV} respectively. The pressure of the assigned accumulator SP_{I} and SP_{II} is detected respectively via these pressure sensors P_{SPI} and P_{SPII}. Furthermore, in each case a pressure sensor 6 is connected to the two working lines A, B in the region of the connections of the primary hydraulic machine 1. The pressure of the working lines A, B and consequently the inlet and the outlet pressure of the primary hydraulic machine 1 are detected via the pressure sensors 6. The pressure sensors P_{SPI}, P_{SPII}, 6 are connected to the control unit OBE via respective signal lines (not shown).

In a braking mode of the travel drive according to the disclosure, the two secondary hydraulic machines 2, 3 act as pumps, in which case a travel direction is assumed which leads to a conveyance of pressure medium out of the working line A into the working line B. In this example, the first accumulator SP_{I} is selected for charging by the control unit OBE, while the at least partially filled second accumulator SP_{II} is to serve for compensating the discharged pressure medium quantity. For this purpose, the first accumulator SP_{I} is connected via the first valve V_{I} to the working line B carrying high pressure and the second accumulator SP_{II} is connected via the fourth valve V_{IV} to the working line A carrying low pressure. The desired braking torque is set via the pivot angles of the two secondary hydraulic machines 2, 3. When the first accumulator SP_{I} is filled, the two valves V_{I}, V_{IV} are closed again. If braking is to be continued, this takes place via high-pressure valves (not shown) of the primary hydraulic machine 1.

During a travel mode, in particular during acceleration, in this example, the first accumulator SP_{I} is connected, as a function of the direction of travel, via the first or second pilot-controlled nonreturn valve V_{I}, V_{II} to the working line A, B carrying high pressure when the accumulator pressure measured by the pressure sensor P_{SPI} lies above the operating pressure, transferred by the pressure sensor 6, of the working line A, B carrying high pressure.

Regenerative braking is consequently possible, in which case the connections of the accumulators SP_{I}, SP_{II} to the working lines can be made with low loss by means of the pilot-controlled nonreturn valves V_{I}, V_{II}, V_{III}, V_{IV}.

In contrast to the exemplary embodiment of the travel drive according to the disclosure, as shown, the pressure sensors P_{SPI}, P_{SPII} of the two accumulators SP_{I}, SP_{II} may even be dispensed with. At the end of charging, the OBE must then, by closing the nonreturn valves, store the accumulator pressure which was transferred by the pressure sensors 8 connected to the working lines A, B.

What is disclosed is a hydraulic travel drive with a primary hydraulic machine and with at least one secondary hydraulic machine which are connected to one another in a closed hydraulic circuit via a first and a second working line. In this case, a first accumulator can be connected via a first valve to the first working line and via a second valve to the second working line. Furthermore, a second accumulator can be connected via a third valve to the first working line and via a fourth valve to the second working line. The four valves are non-proportional switching valves, each with two defined switching positions. A travel drive is consequently provided which is simplified in terms of apparatus and the energy efficiency of which is improved.

What is disclosed, furthermore, is a method for operating an above-described travel drive, which method serves for the recuperation of braking energy and has the following steps: recognition of a braking mode of the travel drive; comparison of the pressure in the working line carrying high pressure with the pressure of the first accumulator; if pressure in the accumulator is lower than in the working line, on the one hand, the first accumulator is connected to the working line carrying high pressure and is thereby charged and, on the other hand, the second accumulator is connected to the working line carrying low pressure for the purpose of volume compensation; the pressure of the working line carrying high pressure is compared permanently with the pressure of the first accumulator; until pressure in the charged accumulator corresponds to that of the working line; and the two accumulators are separated from the two working lines.

In a continuation of the method according to the disclosure, there follow the steps: recognition of a travel mode of the travel drive; comparison of the pressure in the working line carrying high pressure with the pressure of the first accumulator; and if pressure in the accumulator is higher than in the working line, on the one hand, the first accumulator is connected to the working line carrying high pressure for the purpose of infeed and, on the other hand, the second accumulator is connected to the working line carrying low pressure for the purpose of volume compensation.

### List of Reference Symbols

V_{I} First pilot-controlled Nonreturn Valve

V_{II} Second pilot-controlled Nonreturn Valve

V_{III} Third pilot-controlled Nonreturn Valve

V_{IV} Fourth pilot-controlled Nonreturn Valve

SP_{I} First Accumulator

SP_{II} Second Accumulator

OBE Electronic Control Unit

P_{SPI}, P_{SPII} Pressure Sensor

A Second Working Line

B First Working Line

T Tank

1 Primary Hydraulic Machine

2, 3 Secondary Hydraulic Machine

4 Displacement Transducer

6 Pressure Sensor

7 Feed Pump

8 Branch Line

What is claimed is:

1. A hydraulic travel drive, comprising:
a primary hydraulic machine;
a secondary hydraulic machine connected to the primary hydraulic machine in a closed hydraulic circuit via a first working line and a second working line;
a first accumulator being connectable via a first valve to the first working line and via a second valve to the second working line; and
a second accumulator being connectable via a third valve to the first working line and via a fourth valve to the second working line,
wherein the valves are switching valves.

2. The hydraulic travel drive according to claim 1, wherein the switching valves are pilot-controlled nonreturn valves.

3. The hydraulic travel drive according to claim 1, further comprising an electronic control unit by which a respective pivot angle and a respective rotational speed of the hydraulic machines are configured to be detected and by which the switching valves are configured to be switched.

4. The hydraulic travel drive according to claim 3, further comprising a pressure sensor arrangement by which respective inlet and outlet pressures of the hydraulic machines and of the two accumulators are configured to be detected and transferred to the control unit.

5. A method for operating a hydraulic travel drive including a primary hydraulic machine, a secondary hydraulic machine connected to the primary hydraulic machine in a closed hydraulic circuit via a first working line and a second working line, a first accumulator being connectable via a first valve to the first working line and via a second valve to the second working line, and a second accumulator being connectable via a third valve to the first working line and via a fourth valve to the second working line, the valves being switching valves, the method comprising:
recognizing a braking mode of the travel drive;
comparing a pressure in the working line carrying high pressure with a pressure of the first accumulator;
connecting the first accumulator to the working line carrying high pressure and connecting the second accumulator to the working line carrying low pressure;
comparing the pressure in the working line carrying high pressure with the pressure of the first accumulator;
separating the two accumulators from the two working lines;
recognizing a travel mode of the travel drive;
comparing the pressure in the working line carrying high pressure with the pressure of the first accumulator; and
connecting the first accumulator to the working line carrying high pressure and connecting the second accumulator to the working line carrying low pressure.

6. The method according to claim 5, further comprising, in the braking mode after the connection of the first accumulator to the working line carrying high pressure and the connection of the second accumulator to the working line carrying low pressure, regulating braking torque by setting a pivot angle of the secondary hydraulic machine.

7. The method according to claim 5, further comprising, in the braking mode after the separation of the two accumulators from the two working lines, regulating braking torque via high-pressure valves of the primary hydraulic machine.

8. The method according to claims 5, further comprising, in the travel mode after the connection of the first accumulator to the working line carrying high pressure and the connection of the second accumulator to the working line carrying low pressure, regulating travel by setting a pivot angle of the secondary hydraulic machine.

9. The method according to claim 8, further comprising regulating travel by setting a pivot angle of the primary hydraulic machine.

10. The method according to claim 5, wherein respective rotational speeds and respective inlet and outlet pressures of the hydraulic machines are used to recognize the braking mode and the travel mode.

11. The method according to claim 5, further comprising storing a pressure value of the first accumulator in the control unit before the separation of the two accumulators from the two working lines.
